(19) United States
(12) Patent Application Publication
(10) Pub. No.: US 2007/0071201 A1
(43) Pub. Date: Mar. 29, 2007

(54) Payphone control

(76) Inventors: Michael Gregory Pettus, Dana Point, CA (US); Robert Michael Reagan, San Jose, CA (US); Darryl Harrington Thomas, San Francisco, CA (US); Kim Blake Peterson, San Jose, CA (US); Roger T. Haas, Scotts Valley, CA (US)

Correspondence Address: FISH & RICHARDSON P.C., PO BOX 1022, MINNEAPOLIS, MN, 55440-1022, US

(21) Appl. No.: 11/489,741

(22) Filed: Jul. 18, 2006

Related U.S. Application Data
(60) Provisional application No. 60/700,479, filed on Jul. 18, 2005.

(51) Int. Cl. H04M 17/00

(52) U.S. Cl. 379/144.05

(57) ABSTRACT

Systems and methods are provided for controlling pay telephones. In one implementation a system is provided. The system includes a pay telephone coupled to a telephone server using a telephone line. The system also includes a local control unit located in proximity to the pay telephone and coupled between the pay telephone and the telephone server, the signaling unit configured to provide signaling voltages associated with pay telephone operation.

### CROSS-REFERENCE TO RELATED APPLICATIONS

This application claims the benefit of U.S. Provisional Application No. 60/700,479, filed on Jul. 18, 2005, which is hereby incorporated by reference in its entirety.

### BACKGROUND

The present disclosure relates to communications systems.

Conventional pay telephones provide communication between the pay telephone and another location using phone lines connected through a public switched telephone network (“PSTN”). Typically, a user provides payment (e.g., one or more coins) in order to place a call using the pay telephone. The call is connected by a central office providing telephone routing through the PSTN. Conventional pay telephones typically do not include internal signaling and coin control apparatus. Instead, pay telephones receive signaling from a remote location (e.g., the central office of the telephone service provider) in order to provide coin control and management functions. The remote location typically provides coin control and management functions using human operators or electronic switching systems, for example, using switch-generated coin signaling.

### SUMMARY

Systems and methods are provided for controlling pay telephones. In general, in one aspect, a system is provided. The system includes a pay telephone coupled to a telephone server using a telephone line. The system also includes a local control unit located in proximity to the pay telephone and coupled between the pay telephone and the telephone server, the signaling unit configured to provide signaling voltages associated with pay telephone operation.

Implementations of the system can include one or more of the following features. The system can further include a control server, the control server coupled to the control unit through a network. The control server can provide management functions for the control unit. The management functions can include authorizing pay telephone operation using phone payment detected by the signaling unit, call detail reporting, call rating information, and voice over IP packet routing information. The management functions can also include control logic for pay telephone signaling voltages.

The control unit can further include a plurality of voltage switches operable to provide one or more signal voltages to the pay telephone. The control unit can include control logic for pay telephone signaling voltages.

In general, in another aspect, a method is provided. A deposited payment is detected at a local control device, the deposited payment occurring at a pay telephone. A control signal is received at a control unit coupled to the pay telephone. A switched signal is generated according to the control signal. The switched signal is transmitted to the pay telephone.

Implantations of the method can include one or more of the following features. The method can further include determining if a call attempt is successful and generating a switched signal depending on whether the call attempt is successful. If the call attempt is not successful, a switched signal can be generated instructing the pay telephone to return the deposited payment. If the call attempt is successful, a switched signal can be generated instructing the pay telephone to retain the deposited payment. The method can further include detecting a number dialed at the pay telephone, determining a call rating for the number, and requesting additional payment according to the call rating.

Particular embodiments of the invention can be implemented to realize one or more of the following advantages. Additional functionality can be provided for pay telephones without performing modifications to a remote system maintaining the individual pay telephones or to the pay telephones themselves. A switching device can be coupled to one or more pay telephones in order to provide coin control and other signaling functions to the pay telephone that previously were provided by a central telephone office. Switching commands can be provided by a remote server over a network using the Internet Protocol (“IP”). The IP network connection can also be used to provide voice service (VoIP) to the pay telephone, routing calls over an IP network instead of using a public switched telephone network (“PSTN”). Additionally, a pay telephone control device can provide additional functionality unavailable in a conventional pay telephone setting. The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an exemplary communication system.

FIG. 2 shows a block diagram of an example pay telephone signaling unit as part of a communication system.

FIG. 3 shows an example pay telephone communication process.

FIG. 4 shows an example VoIP system including a pay telephone.

FIG. 5 shows an example VoIP process.

FIG. 6 shows an example process for pay telephone operation.

Like reference numbers and designations in the various drawings indicate like elements.

### DETAILED DESCRIPTION

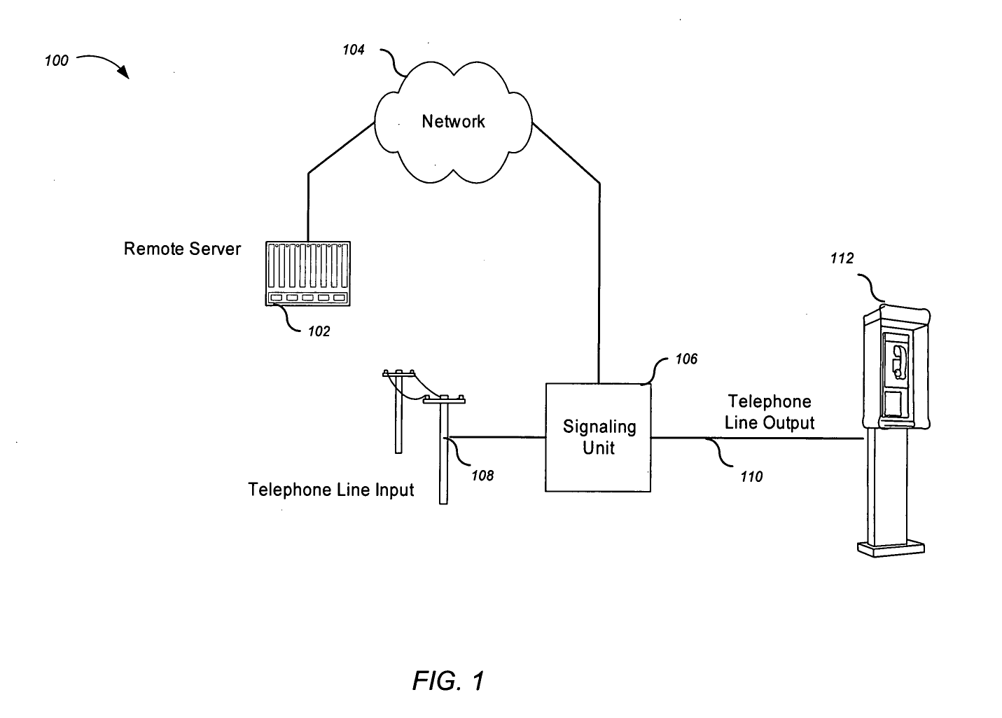

FIG. 1 shows a block diagram of an exemplary communication system 100. The communication system 100 includes a remote server 102, a network 104, a control unit 106, a line input 108, a line output 110, and a pay telephone 112.

In one implementation, the remote server 102 and control unit 106, together or independently, can provide authentication, authorization, call rating information, packet routing information (e.g., for VOIP), interactive voice response, call detail reporting, and remote provisioning to one or more pay telephones (e.g., pay telephone 112).

The remote server 102 can provide central management to coordinate the functions provided by the control unit 106 for each particular pay telephone 112. The remote server 102 can be coupled to the control unit 106 through network 104. In one implementation, the network 104 is a wide area network and the remote server 102 and pay telephone 112 can be coupled using one or more network connections (e.g., an Ethernet, cable, wireless, or other form of network connection).

The control unit 106 can be used to provide different functionality for the pay telephone 112. For example, the control unit 106 can include a signaling unit for providing signaling voltages to operate the pay telephone 112. In another implementation, the control unit 106 can also provide a VoIP gateway, routing communications over a network such as the internet using an IP protocol instead of through the telephone network (e.g. PSTN). In one implementation, the control unit 106 is configured to provide several optional functions controlled by the remote server 102.

The line input 108 and line output 110 can be used to provide incoming and outgoing communications. The line input 108 can provide a communications link from a telephone network such as a PSTN to the pay telephone 112 as well as provide transport services for communications from the pay telephone 112 to the telephone network (e.g., voice telephone calls). In one implementation, the control unit 106 can be positioned between the line input 108 and the line output 110.

The line input 108 is joined to the control unit 106, while the line output 110 joins the pay telephone 112 and the control unit 106. In one implementation, communications for the pay telephone 112 using the line output 110 are routed between the pay telephone 112 and the remote server 102, bypassing the line input 108 (e.g., for placing VoIP calls). In one implementation, the line input 108 and line output 110 are each analog telephone lines.

The pay telephone 112 provides access to one or more communications networks (e.g., to a user). For example, the pay telephone 112 can allow a user to deposit a coin in order to become authorized to place a call using the pay telephone 112. For example, after depositing payment, the user can dial a telephone number in order to establish voice communications with another individual. Alternatively, the pay telephone 112 can be configured to receive telephone calls (e.g., in response to an external individual or device dialing a telephone number associated with the pay telephone 112).

Signaling Control

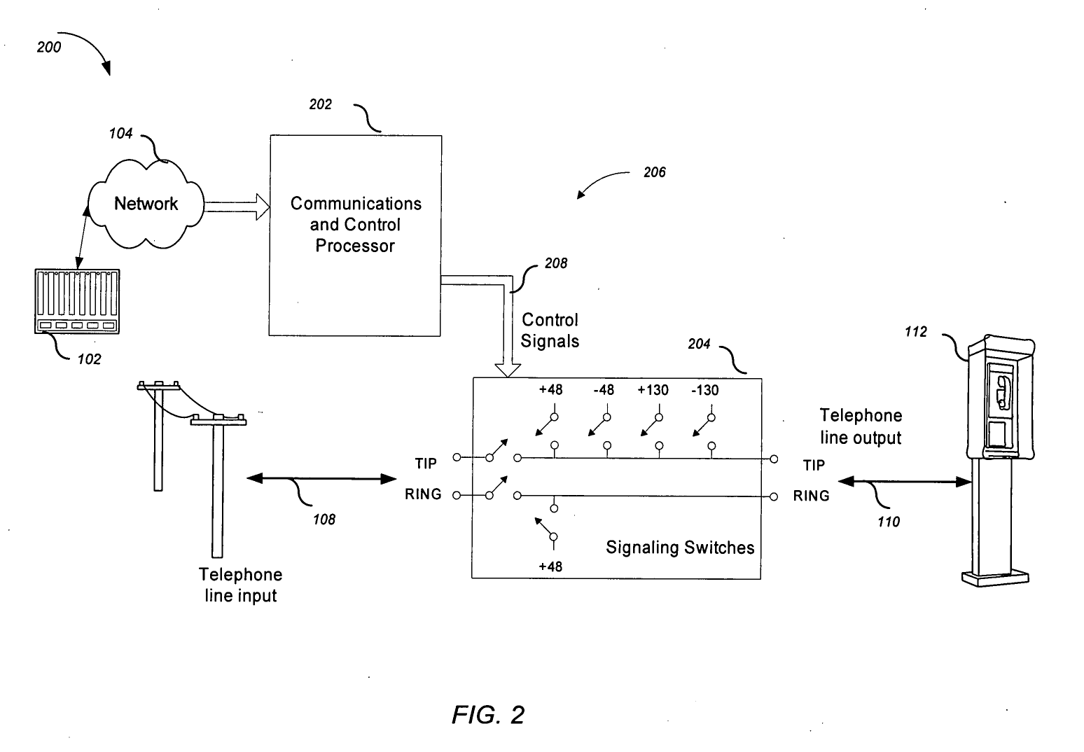

FIG. 2 shows a block diagram of an exemplary signaling unit 206 for use with, for example, the communications system 100 of FIG. 1. In one implementation, the signaling unit 206 is a component of the control unit 106. Alternatively, the signaling unit 206 can be a stand alone device. The signaling unit 206 includes a management device 202 and a switching device 204. The management device 202 can provide control signals to the switching device 204. In one implementation, the management device 202 receives commands from remote server 102 through network 104, which can result in control signals being transmitted to the switching device 204.

The switching device 204 includes a number of controllable switches along two switching paths on the TIP and RING wires (The TIP wire and the RING wire are wires used to connect a conventional phone to a central PSTN connection). The switches can be manipulated in response to control signals in order to transmit a particular signal to payphone 112. The TIP and RING lines can independently be open or closed (ground). Additionally, a plurality of voltages can be applied to the respective TIP/RING paths.

For example, in one implementation, to signal a coin return, e.g., when no answer is received to a dialed call, the TIP switch can be set to −130 volts, while the RING switch remains open. The signal, when received by the pay telephone 112, directs the pay telephone 112 to return the deposited payment to the user. The signaling time can vary depending on the particular configuration used and other factors, however, in one implementation, the coin return signal is provided for substantially 500 ms. Table 1 shows some exemplary signal types and switching configurations for pay telephone signaling control, as well as example signaling duration.

TABLE 1

| | TIP switch | RING | |
|---|---|---|---|
| Signal Description | (volts) | switch | Time (ms) |
| Stuck Coin Test | +48 | Open | 200-500 |
| Initial Rate Test | −48 | Open | 500 |
| Coin Return | −130 | Open | 500 |
| Coin Collect | +130 | Open | 500 |
| Reverse Battery | −48 | Ground | Call Connect Time |
| | | (closed) | (optional) |
| Normal Battery | Ground | −48 | Call Connect Time |
| | (closed) | | |
| Operator Attached | Ground | +48 | Variable |
| | (closed) | | |

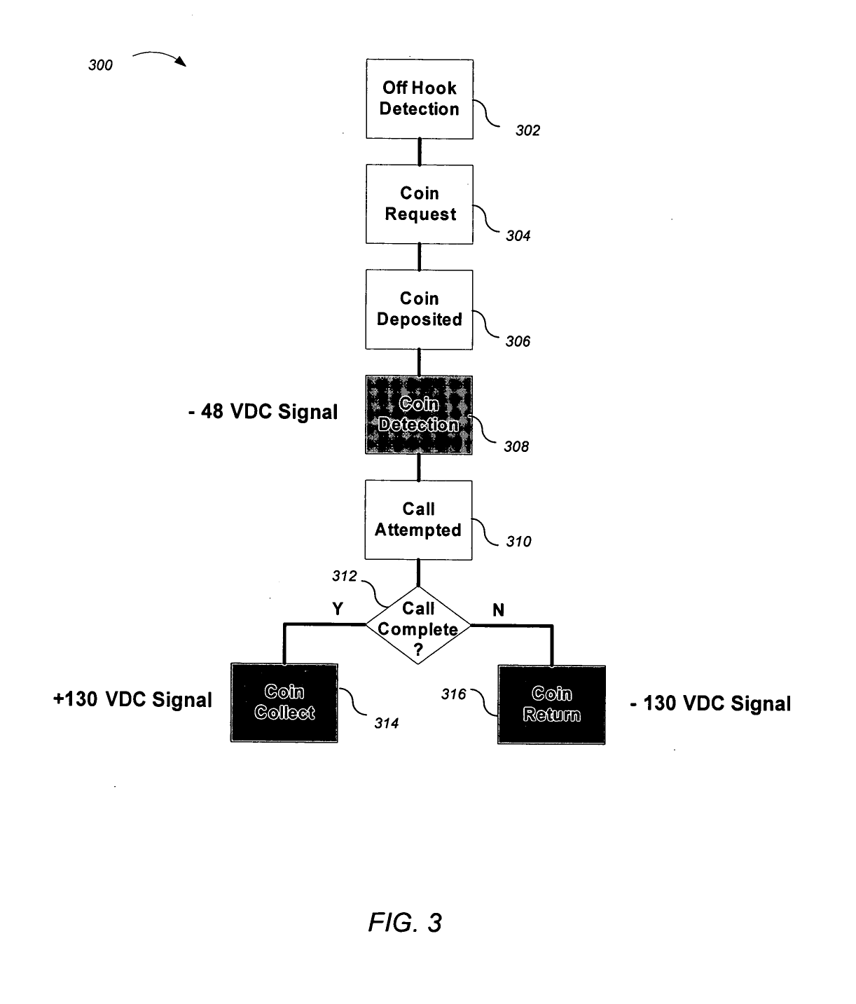

FIG. 3 shows an example process 300 for pay telephone operation using signaling and coin control provided by a signaling unit (e.g., signaling unit 206). When a user wishes to make a call from a pay telephone (e.g., pay telephone 112), the user typically lifts a handset for the pay telephone. When the user lifts the phone handset, the phone detects that the phone is “off hook” (step 302). For example, the handset can be depressing a lever or button which is activates a hook switch when the handset is removed. When the hook switch is activated the pay telephone requests (whether explicitly or implicitly) a coin deposit in order to connect with the telephone network, allowing the user to connect to another device (e.g., another telephone) (step 304). In one implementation, a voice or other prompt is provided to request the deposit of the required payment amount.

The user deposits money in the pay telephone (step 306). For example, the user can deposit one or more coins in a slot on the pay telephone. The number of coins can vary, for example, depending on the type of call being made. In one implementation, the pay telephone can accept other payment forms (e.g., bank notes, credit/debit cards). When the correct amount has been deposited, the pay telephone completes a circuit such that the pay telephone can pass a coin ground test.

When the user dials a number into the pay telephone, the signaling unit can provide coin detection to verify the user is allowed to place a call (e.g., that payment has been deposited) (step 308). The coin detection includes performing an initial rate test. In one implementation, the initial rate test includes sending a voltage signal to the pay telephone and measuring the resistance to ground. In one implementation, the voltage signal is −48 VDC as shown in Table 1 above. If the measured resistance is infinite, the call is considered unpaid because the pay telephone didn't complete the required circuit indicated deposit received. If the resistance is at or below some threshold level (e.g., because the pay phone closed the circuit after coins were deposited), the call is considered paid. If the call passes the initial rate test, the signaling unit allows the call to pass and the connection is attempted (step 310). In one implementation, the signaling unit forwards the dialed number to the PSTN for connection to the target device. In an alternative implementation, the signaling unit forwards the dialed number to a VoIP server to connect with the target device.

A determination is made as to whether or not the call is completed (e.g., the destination phone is answered) (step 312). If the call is completed, the signaling unit can send a coin collection signal to the pay telephone so that the coins are deposited within the pay phone (e.g., in a secure coin box for later collection) (step 314). In one implementation, the coin collect signal is a +130 VDC signal provided as shown in Table 1 above. If the call is not completed (e.g., a busy signal or no answer by the destination device), the signaling unit can send a coin return signal to the pay telephone so that the coins inserted by the user are returned (e.g., through a coin return slot in the pay telephone) (step 316). In one implementation, the coin return signal is a −130 VDC signal provided as shown in Table 1 above.

Voice Over Internet Protocol

In one implementation, the call attempts can be routed over a network other than the PSTN telephone network to provide VoIP calls. For example, a control unit (e.g., control unit 106) can also include a call routing device for routing the call from the control unit over the network (e.g., network 104), bypassing the PSTN and line output 108. Thus, both payphone signaling and call routing can be provided by the control unit coupled between the payphone and the PSTN.

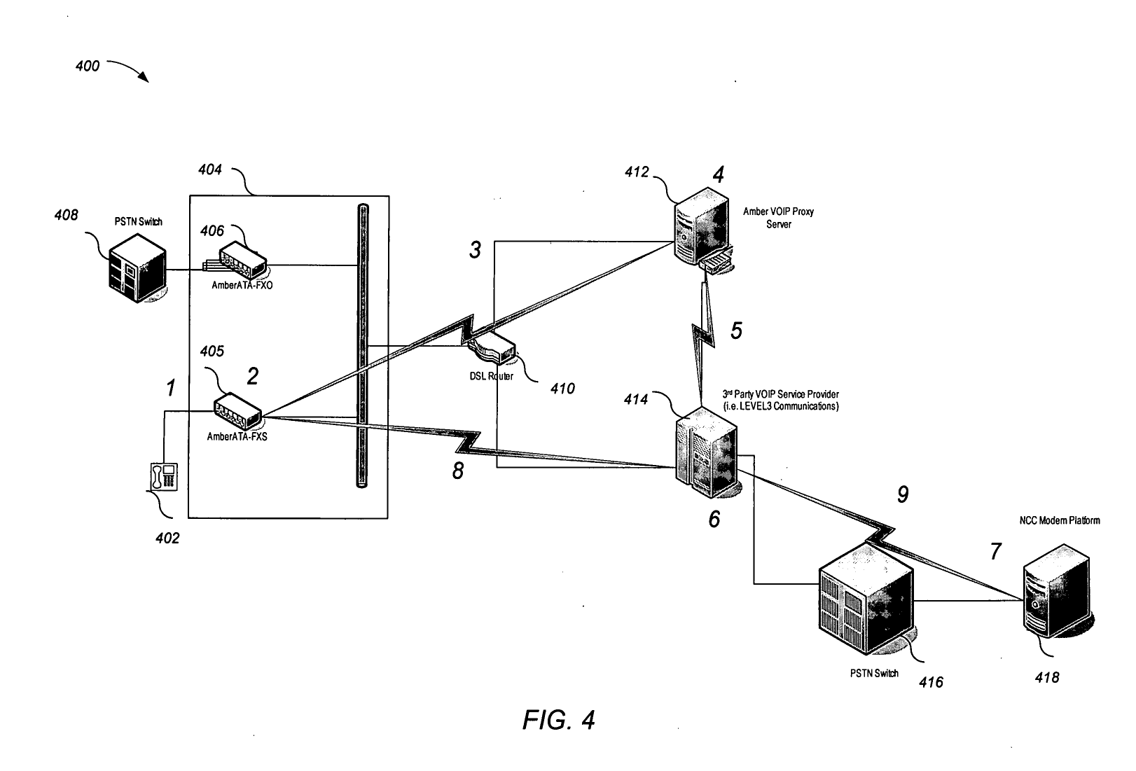

FIG. 4 shows an exemplary VoIP system 400 for routing pay telephone communications. VoIP system 400 includes a pay telephone 402, a pay telephone control device 404, a first PSTN connection 408, a router 410, a proxy server 412, a VoIP server 414, a second PSTN connection 416, and a target device 418.

The pay telephone 402 can be similar to pay telephone 112 discussed above with reference to FIG. 1. A user of the pay telephone can place a call after depositing a correct amount of money (e.g., one or more coins) as required, for example, by a pay telephone service provider associated with the pay telephone.

The pay telephone control device 404 controls the routing of telephone calls placed by the pay telephone. In one implementation, the pay telephone control device 404 can include signaling components such as provided by signaling unit 106 described above with reference to FIG. 1. The pay telephone control device 404 includes a first port 405 and a second port 406. The first port 405 connects the pay telephone control device 404 to a network (e.g., WAN, Internet). The pay telephone control device 404 includes an analog to digital converter or similar device for converting analog voice signals from the pay telephone to digital data. The second port 406 connects the pay telephone control device 404 to the first PSTN switch 408.

The first PSTN switch 408 provides a connection between the pay telephone 402 and the PSTN network. In one implementation, the PSTN switch 408 can route external calls in the PSTN network to the pay telephone 402. Additionally, the pay telephone control device 404 can route particular calls from pay telephone 402 through the PSTN network using the PSTN switch 408 (e.g., for particular types of calls or when the network connection through the first port 405 is unavailable).

The proxy server 412 receives call requests from the pay telephone control device 404 (e.g., routed through first port 405) through one or more network routers such as router 410. The proxy server 412 can manage incoming VoIP requests from pay telephones such as pay telephone 402 and route the requests to the VoIP server 414 to complete the VoIP connection. In one implementation, the proxy server 412 can use the originating pay telephone number to determine whether an area code should be appended to the received destination number.

The VoIP server 414 can route the call to the target device 418 in order to complete a connection. In one implementation, the target device 418 is another telephone or a modem connected to the PSTN network. Thus, the VoIP server 414 can route the call back to the PSTN through the second PSTN switch 416. Alternatively, the target device 418 can be a device connected to the network such as an IP telephone or a computer with a high speed network connection. When the target device 418 is directly connected to the network, the VoIP server 414 can route the call directly to the target device 418 to establish a connection.

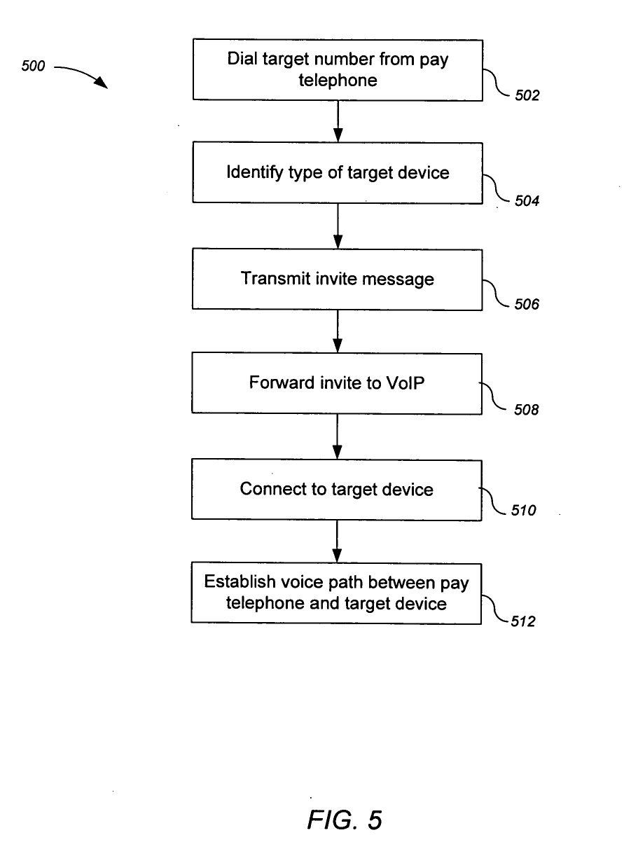

FIG. 5 shows an example VoIP process 500 for connecting a pay telephone (e.g., pay telephone 402) with a target device (e.g., target device 418), routing outside the PSTN. A user dials a target device number from the pay telephone (step 502). The target device is identified, for example, by a pay telephone control device (e.g., pay telephone control device 404) (step 504). In one implementation, the pay telephone control device can use the dialed number to identify a particular number as being directed to another telephone, a modem, or another device type. In one implementation, the control device can select a particular encoding depending on the type of target device (e.g., select a particular codec). For example, if the dialed number is 237-6807, the target device can be recognized as a FSH modem and the control device can configure the call to be carried using codec m711.

An invite message is transmitted by the pay telephone control device to a remote location such as a server or proxy server (e.g., proxy server 412) (step 506). The invite message can includes the originating caller telephone (or direct dial (“DID”)) number and the destination number. Based on the number of the pay telephone and the destination, the proxy server can append an area code to the destination number if needed. For example, in the example above, the phone number 237-6807 can become 1-801-237-6807.

The invite message is forwarded to a VoIP operator such as a particular VoIP server (e.g., VoIP server 414) (step 508). The VoIP operator connects with the target device using the destination number provided by the proxy server (e.g., proxy server 412) (step 510). The VoIP server can connect in different way depending on the type of target device. For example, if the target device is a modem or telephone, the VoIP operator can convert the invite message into a PSTN setup message, which is then forwarded to a PSTN switch (e.g., the second PSTN switch 416). In an alternative implementation, if the target device is another network device (e.g., an IP telephone, cable modem, Ethernet, and so forth), the VoIP server can connect directly using one or more VoIP protocols. In one implementation, if the connection to the target device is successful, an acknowledgement message is sent from VoIP server to the pay telephone control device. In one alternative implementation, the control unit can send the invite message directly to the VoIP operator.

After connecting with the target device, a voice path is established between the pay telephone and the target device (step 512). In one implementation, the voice path can include a voice connection between the pay telephone control device and the VoIP server and a voice path between the VoIP server and the target device. In one implementation, the voice path between the pay telephone control device and the VoIP server bypasses the proxy server. If the target device is connected to the PSTN network, the VoIP server can perform the proper conversion to and from the PSTN network.

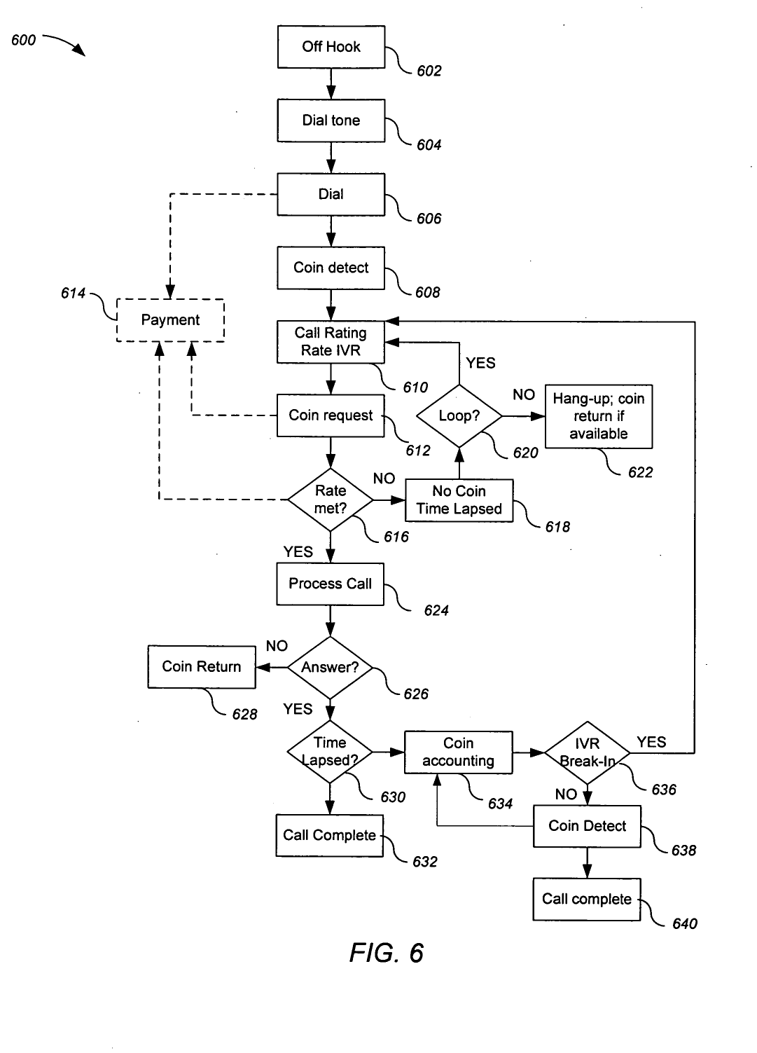

FIG. 6 shows an example process 600 combining the coin control and call routing features for a pay telephone. The pay telephone receiver is taken off hook (step 602). For example, a user of the pay phone lifts the receiver to place a call. Taking the phone off hook produces a dial tone for the user, indicating that the phone is connected to the telephone system (e.g., to the PSTN network) (step 604). The user deposits coins and dials a number to attempt a connection with another device (e.g., another telephone) (step 606). The coin deposit is detected, for example, using a pay telephone control device connected between the pay telephone and the PSTN network (step 608). The pay telephone control device can include a signaling unit which sends a switched signal (e.g., an initial rate test) to the pay telephone to test whether or not coins have been deposited.

Call rating is performed (step 610). Different types of calls can require different payment amounts. The call rating determines whether or not additional payment is required to place the call based, for example, on destination phone location (e.g., it may cost more to connect long distance than locally). In one implementation, the payment amount can vary depending on the type of destination device (e.g., less for a PSTN phone than for an IP phone or modem).

A coin request is performed for additional payment if necessary (step 612). In one implementation, voice prompts are provided for requesting deposit payments amounts. The voice prompts can be provided, for example, by the control unit or by a remote server connected to the control unit. The total payments received (e.g., prior to dialing and any additional payments) can be stored (step 614). A determination is made as to whether or not the rate for the desired call has been met (step 616). For example, whether or not the user has deposited enough additional coins to reach the payment amount required to make a particular type of call. In one implementation, user deposit amounts are monitored (e.g., credit card transaction or coin tones). If the required payment has not been made (step 618) a determination is made as to whether or not to loop the payment request or not (step 620). If the payment request loops (i.e., repeats the request), the coin request is made again. If the payment request does not loop, the call attempt is terminated and the deposited payment is returned (step 622).

If the required payment amount has been met at step 616, the call is processed (step 624). In one implementation the call can be forwarded to the target device through the traditional PSTN network. In another implementation, the call is routed over a VoIP network (e.g., by the pay telephone control device) to a target device which can be network based (e.g., an IP phone, Ethernet connection, and so on) or another PSTN connected device (e.g., another telephone).

A determination is made as to whether the target device has answered the call (i.e., whether or not the connection was successful) (step 626). If the target device did not answer, the call attempt terminates and the pay telephone is signaled to return the deposited payment to the user (step 628). If the call is answered a determination of whether time has elapsed (step 630). If time has not elapsed (e.g., an immediate disconnect), the call is considered completed (step 632).

If time has elapsed a coin accounting tracks the time elapsed with respect to the amount of time paid for by the user (step 634). For example, in one implementation, the initially deposited payment amount only covers a predefined period of time (e.g., the first five minutes). In an alternative implementation, however, the initial deposit covers an indefinite time period (e.g., for local calls, which may have not time limit once the initial deposit is made).

When the user's paid for time period is approaching or reaches expiration, a determination is made as to whether to break-in to the call (step 636). If no break-in is performed, for example because the user deposited additional payment within a particular period of time, the additional payment is detected (step 638). The call can then continue until complete (step 640) or until additional payment is required (e.g., after completion of one or more additional time periods). If the user's paid for amount of time runs out or is exceeded without additional payment deposited, the call can be broken-in until further payment is received (returning to step 610). If further deposits are received, the call is reconnected (repeating steps 624 to 634). If further deposits are not received, the call can time out and terminate (step 622).

Functions Performed by Pay Telephone Control Device

In one implementation, the call rating and accounting functions can be performed by the pay telephone control device independent of any PSTN network control system. The pay telephone control device can then provide call information to the telephone service provider.

In one implementation, the pay telephone control device collects a record of dialed calls. For example, the collection of dialed telephone numbers can then be submitted to the appropriate telephone service provide (e.g., local, long distance, international) for billing and accounting purposes.

In one implementation, the type of call can be determined based on an examination of the dialed digits. The type of call can be used to determine the accounting as well as particular routing of the call (e.g., PSTN or VoIP). For example, the dialed digit string can have several distinct lengths including 3 digits, 7 digits, 10 digits, and 11 digits. In one implementation, some or all three digit calls are routed to the local telephone service provider (e.g., directory assistance “411” or emergency “911” calls). In an alternative implementation a particular three digit number (e.g., 011) routes instead to an enhanced service platform as indicated of a request for international dialing assistance. In another implementation, 7 digit numbers and 10 digit local numbers are routed to the local service provider while 10 and 11 digit non-local calls can be routed to one or more regional providers.

In one implementation, call rating can be provided by the pay telephone control device by examining the dialed number with respect to a rate table. The rate table defines different payments amount necessary for calls based, for example, on the type of call and the distance between the pay telephone and the target device. The call rating table can also be used to determine if enough payment has been received and what additional payments are needed based on elapsed call time (e.g., according to a call timer in the control unit). Call rating can be provided by the control unit or by one or more remote servers connected to the control unit.

Voice prompting to the user for particular user actions. In one implementation, voice prompts can indicate a required payment (e.g., based on the call rating) in order to place a call. For example, after dialing a particular number, the user of the pay telephone could receive the following voice prompt: “Please deposit one dollar for the first three minutes.” The voice prompt can change as the user deposits payment (e.g., prompting the declining balance). For example, after depositing a quarter, the voice prompt can change to a request for 75 cents. In another implementation, other voice announcements can be provided. For example, the user can be provided with a “thank you” announcement once payment has been complete as well as progress updates. Additionally, the voice announcement can prompt the user to “please hang-up” once a call is completed or otherwise terminated (e.g., disconnect for insufficient payment). In one implementation, the voice prompting can be provided by a remote server connected to the control unit. Alternatively, the control unit itself can provide the voice prompts directly. In one implementation, the voice prompts can be provided in one or more languages.

In one implementation, to determine payment made (e.g., for voice prompting and determining if the total required payment has been received), the pay telephone control device can count coins. Coin counting can include receiving coin tones from the pay telephone for each deposited coin such that the pay telephone control device can track and sum deposited coins. The call can be attempted once the user has deposited an amount equal to or greater than the required amount. In one implementation, the pay telephone control device can mute the pay telephone microphone during the coin detection/counting process (e.g., using a 2-way cable connected across the microphone circuit). Muting the microphone can prevent fraudulent coin tones from being sent by the user from an external source. Thus, the coin counting and detection can be validated.

In one implementation, the pay telephone control includes call timing. Call timing can be performed by local control units or by a server routing the calls (e.g., the VoIP calls). Each time a call is “answered” (e.g., a connection is made with a target device), a timer is initiated. The timer can record the duration of the call. If the duration approaches or exceeds a duration for which payment was received (e.g., according to the call rating), the user can be prompted to deposit additional payment (e.g., an overtime amount) in order to continue the call. The process can repeat for additional overtime periods as needed.

In one implementation, when a user deposits payment into the pay telephone in order to place a call, the pay telephone control device connects to a interactive voice response (“IVR”) platform (e.g., using an “800” number). The pay telephone control device also transmits the phone number of the pay telephone and the number to be dialed (e.g., of the target device) to the IVR platform. The IVR platform can verify the pay telephone number and then connect the call to the target device. In one implementation, the connection to the IVR platform is made using IP protocols across one or more networks external to the PSTN.

In one implementation, records of pay telephone activity can be recorded and reported to one or more telephone service providers. For example, for calls routed by the control unit, records of call duration, deposits made, and numbers dialed can be made and provided to the telephone service providers. Correct accounting and allocation of calls can therefore be made between different service providers. Some or all of the pay telephone activity can be recorded locally by the control unit and then transferred to a remote server, which can aggregate call records from several pay telephones. Pay telephone activity records can be provided to the service providers on-demand or according to a particular delivery schedule. The activity records can be electronically delivered using network transport for example as XML data. The data can be customized to the requirements of each pay telephone service provider.

Additionally, the remote server can update pay telephone information. For example, the remote server can update the control unit with changes to the rate tables. The remote server can also communicate with the control unit to determine status information for the pay telephone. For example, the control unit can provide data on the pay telephone status, the coin contents of the pay telephone, errors or other operational problems with the pay telephone, collection of call detail records.

In one implementation, a wireless access point is connected to the pay telephone in order to provide wireless data access through the pay telephone connection. The wireless access point can be integrated into the pay telephone or coupled to another device such as the control unit. In one implementation, in order to manage and maintain the wireless access point, the wireless access point is coupled to a modem or network connection (e.g., as provided by the control device). Management and maintenance of the wireless access point can be provided remotely through the integrated modem or other network connection using a designated modem number or network address.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A system comprising:
a pay telephone coupled to a telephone server using a telephone line; and
a local control unit located in proximity to the pay telephone and coupled between the pay telephone and the telephone server, the signaling unit configured to provide signaling voltages associated with pay telephone operation.

2. The system of claim 1, further comprising:
a control server, the control server coupled to the control unit through a network.

3. The system of claim 2, where the control server provides management functions for the control unit.

4. The system of claim 3, where management functions include authorizing pay telephone operation using phone payment detected by the signaling unit.

5. The system of claim 3, where management functions include call detail reporting.

6. The system of claim 3, where the management functions include voice over IP packet routing information.

7. The system of claim 3, where the management functions include call rating information.

8. The system of claim 3, where the management functions include control logic for pay telephone signaling voltages.

9. The system of claim 1, the control unit further comprising:
a plurality of voltage switches operable to provide one or more signal voltages to the pay telephone.

10. The system of claim 9, where the control unit includes control logic for pay telephone signaling voltages.

11. A method comprising:
detecting at a local control device a deposited payment, the deposited payment occurring at a pay telephone;
receiving a control signal at a control unit coupled to the pay telephone;
generating a switched signal according to the control signal; and
transmitting the switched signal to the pay telephone.

12. The method of claim 11, further comprising:
determining if a call attempt is successful;
generating a switched signal depending on whether the call attempt is successful.

13. The method of claim 12, where if the call attempt is not successful, generating a switched signal instructing the pay telephone to return the deposited payment.

14. The method of claim 12, where if the call attempt is successful, generating a switched signal instructing the pay telephone to retain the deposited payment.

15. The method of claim 11, further comprising:
detecting a number dialed at the pay telephone;
determining a call rating for the number; and
requesting additional payment according to the call rating.
